(19) United States
(12) Patent Application Publication
(10) Pub. No.: US 2007/0266804 A1
(43) Pub. Date: Nov. 22, 2007

(54) Multi-Part Seismic Cable

(76) Inventors: Nicolas Goujon, Oslo (NO); Johan Fredrik Naes, Trondheim (NO); Rune Voldsbekk, Drammen (NO)

Correspondence Address: WesternGeco, 10001 Richmond Avenue, Houston, TX, 77042, US

(21) Appl. No.: 10/529,186

(22) PCT Filed: Oct. 7, 2003
(86) PCT No.: PCT/EP03/50702

§ 371 Date: May 1, 2007

(30) Foreign Application Priority Data
Oct. 12, 2002 (GB) 0223842.6

(51) Int. Cl. G01D 21/00

(52) U.S. Cl. 73/866.5

(57) ABSTRACT

A seismic cable (110) and a method for assembling such a seismic cable are disclosed. The seismic cable (110) includes a support cable (205) and a signal cable (210) attached to the support cable (205) at a plurality of points spaced along the length of the signal cable (210). The seismic cable (110) also includes at least one sensor module (220) disposed on the signal cable (210). The method includes attaching a support cable (205) to a signal cable (210) at a plurality of points spaced along the length thereof.

### 1. FIELD OF THE INVENTION

This invention relates generally to seismic cable systems, and, more particularly, to a robust and reliable seismic cable system.

### 2. DESCRIPTION OF THE RELATED ART

Subsurface hydrocarbon accumulations are increasingly found in geologically complex areas. The ability to conduct accurate seismic surveys may help improve the discovery rates and even the production of such accumulations. Seismic surveying is a method of stimulating a geological subsurface formation with, e.g., electrical, magnetic, and/or acoustic signals to acquire seismic data about the formation. From this data, one can predict tell whether the formation contains hydrocarbon deposits and, if so, where.

One type of seismic survey is generally referred to as a “marine” survey because it is typically conducted at sea, although this is not necessarily always the case. During marine seismic surveys, seabed seismic cable systems are deployed to the bed of a sea, lake, river, or marsh. The water depth may range from several thousand meters up to the water/land transition zone. Water currents of considerable speed may pass over the cable system and create instability and deterioration of the seismic data quality.

Seabed seismic cable systems generally are designed to meet two conflicting goals. First, the cable system must be robust and resistant to damage. For example, the cable system must survive and operate at great water depth. Also, the cable system may be roughly handled during deployment and retrieval. Second, the cable system should be sensitive to acoustic vibrations and not compromise the quality of data recorded by the sensor units.

Although there are several types of seabed seismic cables, there are generalities in construction. A seabed seismic cable includes three main elements: stress members, leads, and a sheath. One or several stress members take the tension that can be applied to the seabed seismic cable during deployment and retrieval operations to protect other elements of the cable. The leads, which may be electrical or optical, transmit power and/or data, in analog or digital format, along the cable for collection and processing, e.g., on a survey vessel. The sheath is a skin, jacket or extrusion matrix protecting the seabed seismic cable against, notably, water ingress.

One type of seabed cable is known as an “ocean bottom cable” (“OBC”, and is typically equipped with “takeouts.” A full length of conventional OBC is seismic built, the jacket is then opened at the location were the sensors are located, and leads are extracted from the cable to form a take-out and connected to the sensors. The sensors are then attached to the cable.

These types of cable are prone to water intrusion, electrical leakage, and wire kinking, as the take-outs are submitted to a high level of strain during cable handling. These cables usually have an asymmetric cross-section at the sensors, and the response will change depending on how the sensors rest on the seafloor. These types of cables also expose the seismic receivers and the takeouts to a number potentially damaging obstacles on the seabed, thereby reducing the reliability of the collected data. Furthermore, because the takeouts are extracted from the cable and not a separate component, the entire cable may need to be replaced if the takeouts are damaged, which can be expensive and time-consuming.

Improvements to this type of apparatus appear in U.S. Pat. No. 6,294,727 to Orlean, which provides for an “overmolding” of the cable and the sensor units. Improvements also appear in U.S. Pat. No. 6,333,898 to Knudsen et al. and U.S. Pat. No. 6,041,282 to Wardeberg et al. (collective referred as “steel armored cables”), which provide for a preparation of steel armored cable without takeouts. However, the Orlean and steel armored cables still suffer from the drawbacks mentioned above, including water intrusion, electrical leakage, and wire-kinking. Furthermore, the Orlean and steel armored cables usually suffer from the asymmetric cross-section at the sensor units.

Another type of seabed seismic cable system is commonly referred to as a logging type cable. Logging type cables typically have a full electrical/optical termination at each sensor unit, resulting in a high number of connection points. The high number of connection points negatively impacts the cable's reliability. Furthermore, the increased number of terminations makes the sensor unit large and heavy, which negatively impacts data quality.

Yet another type of seabed seismic cable system comprises conventional cables with sensor units integrated inside a protective cable jacket. One variation is known as a “streamer type” cable. The streamer type cable is an evolution of a towed seismic streamer for deployment on the seabed. The streamer type cable comprises spacers, sensor units, and a filler, which usually is oil. The streamer type cable has a constant diameter and therefore occupies a large volume when stored. An alternative variation is known as a “solid cable.” One example of the solid cable is shown in U.S. Pat. No. 6,333,897 to Knudsen et al., which can be produced with a constant diameter or a variable diameter. Both the constant diameter and the variable diameter cables pose potentially serious drawbacks. The cable with a constant diameter is extremely large, heavy and stiff. The cable with a variable diameter is difficult to manufacture.

The present invention is directed to overcoming, or at least reducing the effects of one or more of the problems set forth above.

### SUMMARY OF THE INVENTION

The invention comprises a seismic cable and a method for assembling such a seismic cable. The apparatus comprises seismic cable including a support cable and a signal cable attached to the support cable at a plurality of points spaced along the length of the signal cable. The seismic cable also includes at least one sensor module disposed on the signal cable. The method includes attaching a support cable to a signal cable at a plurality of points spaced along the length thereof.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a seismic survey vessel from which a seismic cable constructed and operated in accordance with the present invention is deployed;

FIG. 2A to FIG. 2C illustrate a first embodiment of the seismic cable of FIG. 1 in accordance with the present invention wherein:

FIG. 2A illustrates in a partially sectioned view of the seismic cable of FIG. 1, in accordance with one embodiment of the present invention;

FIG. 2B illustrates the support cable of FIG. 2A cross-sectioned along line 2B-2B in FIG. 2A; and

FIG. 2C illustrates the signal cable of FIG. 2A cross-sectioned along line 2C-2C in FIG. 2A;

FIG. 3 illustrates a partial view of the seismic cable of FIG. 1, in accordance with one particular embodiment of the present invention in which the support and signal cables are attached by the electronics modules;

FIG. 4 illustrates a storage and deployment mechanism for the seismic cable of FIG. 1, in accordance with a second embodiment alternative to that in FIG. 3 in which the support and signal cables are joined by a zipper mechanism;

FIG. 5 illustrates a partial, perspective, cross-sectioned view of the seismic cable of FIG. 1, in accordance with a third embodiment alternative to those in FIG. 3 and in FIG. 4 in which the support and signal cables are fabricated together and then separated by a rip-cord;

FIG. 6 illustrates a partial plan view of the seismic cable of FIG. 1, in accordance with a fourth embodiment in which the support cable and the signal cable are attached by a rigid arm; and

FIG. 7A and FIG. 7B illustrate a fifth embodiment in a side, plan view and in an end, partially sectioned view (along line 7B-7B), respectively, which the support and signal cables are attached by the housings of the sensor modules.

While the invention is susceptible to various, modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

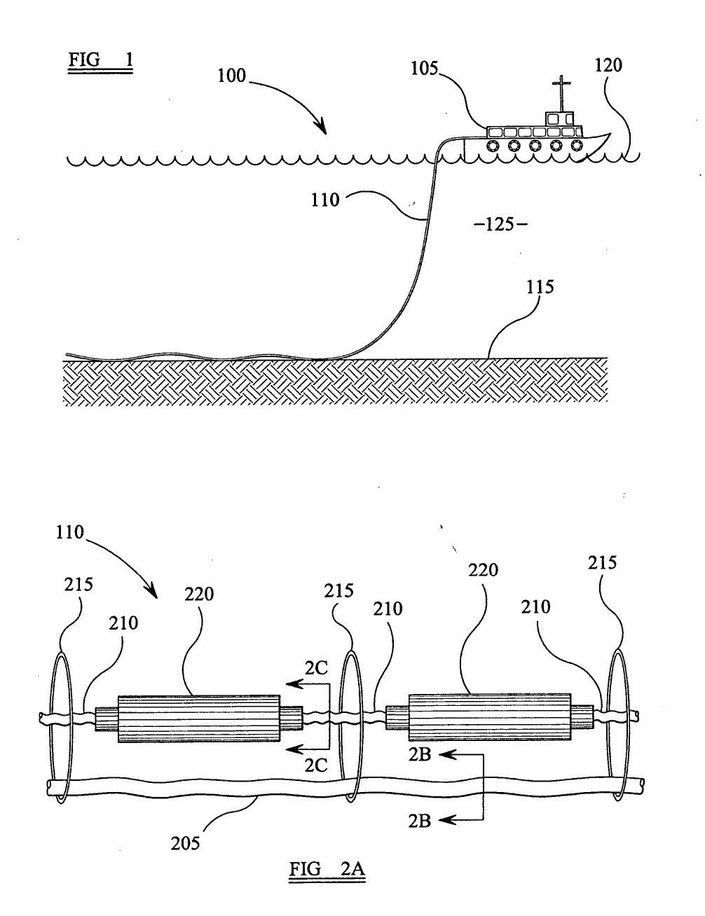

FIG. 1 illustrates a seismic survey system 100 in which a seismic survey vessel 105 has deployed a seismic cable 110 to the bed 115 from the surface 120 of a body of water 125. In the illustrated embodiment, the body of water 125 is part of an ocean. Consequently, the bed 115 is a seabed (or, ocean floor). However, the invention is not so limited, as the invention may used for surveys conducted in fresh and brackish waters.

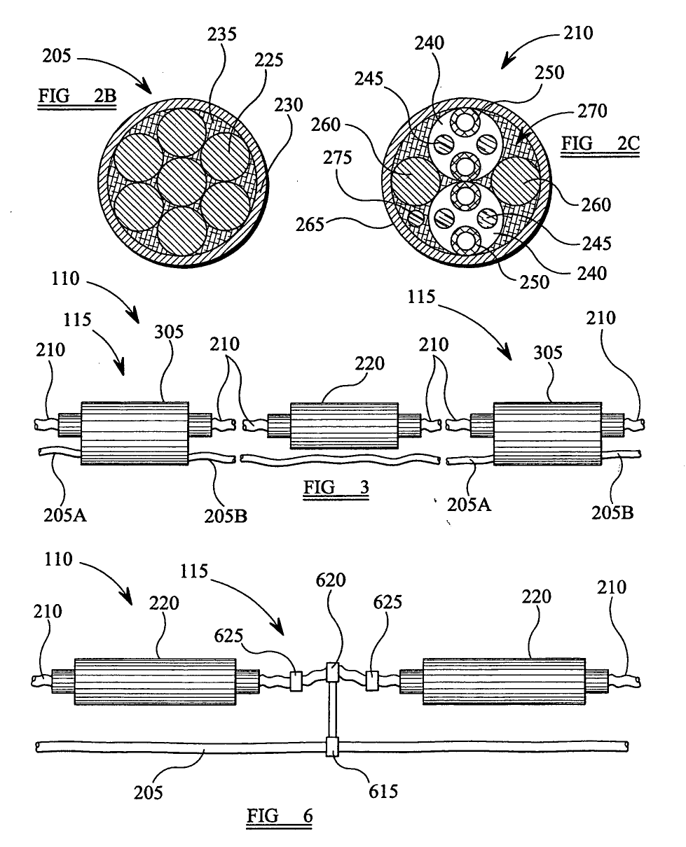

FIG. 2A illustrates a seismic cable 110 in accordance with one embodiment of the present invention. The seismic cable 110 comprises a support cable 205 and a signal cable 210 attached to the support cable 205 at a plurality of points 215 spaced along the length thereof. In the illustrated embodiment, the signal cable 210 further comprises a plurality of sensor modules 220, which will be discussed further below. In one embodiment, the spacing of the points 215 is approximately proportional to a length of the sensor modules 220 so that the points 215 are located between each of the sensor modules 220. However, the present invention is not so limited. In alternative embodiments, the points 215 may be located at any desirable location. For example, the points 215 may be located between every other sensor module 220 or between successive pluralities of sensor modules 220. For another example, a plurality of points 215 may be located between each pair of sensor modules 220.

As is shown in FIG. 2B, the support cable 205 includes one or more stress members 225 (only one indicated) providing tension to the seismic cable 110. The stress members 225 may be any type of stress member known to the art for handling tension in seismic cables. Examples of suitable stress members 225 include, but are not limited to, steel wire and utility cable. If more than one stress member 225 is employed, as in the illustrated embodiment, the stress members 225 may be cabled together in any suitable fashion known to the art. For instance, in the illustrated embodiment, the stress members 225 are jacketed together, i.e., cabled together by enclosure in a jacket 230. Furthermore, in some embodiments, the support cable 205 may be filled with a filler 235 to, e.g., help protect against water intrusion. The filler 235 may be of any suitable type known to the art.

As is shown in FIG. 2C, the signal cable 210 comprises, inter alia, a plurality of signal leads 240, and, in the illustrated embodiment, one or more power leads 260. The signal leads 240 may include electrical leads 245 such as a twisted wire pair of leads, a coaxial cable, and the like. The signal lead 240 may also include one or more optical fibers 250. As with the support cable 205, these elements may be cabled together in any suitable fashion known to the art. For instance, in the illustrated embodiment, the leads 240, 245, 250, 260 are jacketed together, i.e., cabled together by enclosure in a jacket 265. Furthermore, in some embodiments, the signal cable 210 may be filled with a filler 270 to, e.g., help protect against water intrusion. The filler 270 may be of any suitable type known to the art. In the illustrated embodiment, the signal cable 210 also includes a stress member 275 for providing extra support on forces exerted against the signal cable 210, although the invention is not so limited. In alternative embodiments, the signal cable 210 may not include the stress member 275 or may include a plurality of stress members 275.

Returning to FIG. 2A, the signal cable 210, in the illustrated embodiment, further comprises one or more sensor modules 220. The sensor module 220 includes one or more sensors (not shown). Examples of sensors include, but are not limited to, geophones, accelerometers, hydrophones, tilt meters, and magnetometers.

These sensors generate data in the course of survey operations and transmit that data over the signal cable 210 in a conventional manner. The sensors may include electronics for conditioning the signal and/or digitizing it. The sensor module 220 is typically connected to the signal cable 210 by one or more the sensor leads 240, 245, 250, 260 shown in FIG. 2C. Note that the composition of sensors in each sensor module 220 may be the same or may be unique, depending on the implementation. To some degree, the choice of sensors may influence the number and implementation of the signal and power leads (e.g., the leads 240, 245, 250, 260 in FIG. 2C).

The data from the sensors may be transmitted to one or more electronics modules (not shown in FIG. 2A) located along the seismic cable 110 or between cable sections. The electronics module is connected to the signal cable the signal cable 210 by one or more of the signal leads (e.g., the signal leads 240, 245, 250, 260 in FIG. 2C) of the signal cable. Alternatively, the functionality of the electronics module may reside in one or more of the sensor modules 220 in some alternative embodiments. The electronics module serves as a data transmission and power hub for the sensor modules 220. In one embodiment, the electronics module may comprise a high bandwidth bus capable of transmitting data between other electronics modules and to a computer or other computing device (not shown) on the seismic survey vessel 105 or at a remote location. In an alternative embodiment, the sensor module 220 may be connected to the signal cable 210 by a data bus (not shown). Regardless, one important function of the electronics module is to collect and forward the data generated and transmitted by the sensor modules.

In one embodiment, the sensor module 220 is sufficiently sealed to protect against water intrusion and physical damage. However, in alternative embodiments, the seismic cable 110 may be enclosed by a sheath, or protective outer covering (not shown). In embodiments wherein the support cable 205 includes leads, the support cable 205 may also be enclosed by a sheath (not shown). The sheath protects sensitive electronics such as the signal cable 210 and sensor module 220 from water intrusion and physical damage. The protective outer covering can be any skin, jacket, or extrusion matrix known in conventional practice.

Although the support cable 205 bypasses the sensor module 220 as illustrated in FIG. 2A, in an alternative embodiment, a groove can be provided in the sensor module 220 such that the support cable 205 passes through the sensor module 220 via the groove. The support cable 205 can be acoustically decoupled from the sensor module 220 by one or more acoustic decoupling devices (not shown) between the groove and the support cable 205, such as springs or elastic devices, as will be discussed further below.

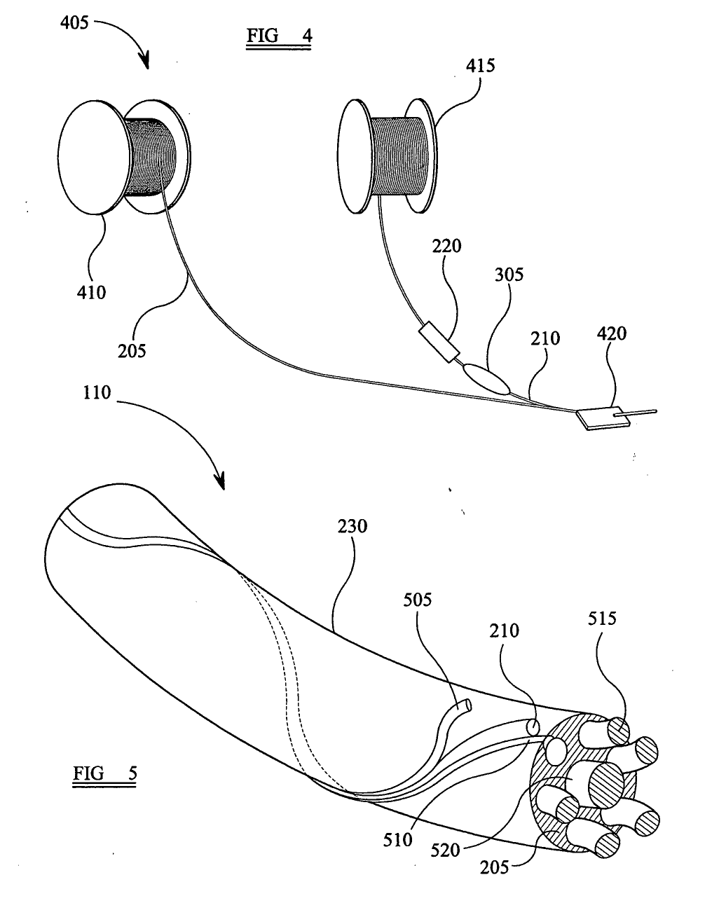

As was mentioned above, the signal cable 210 is attached to the support cable 205 at a plurality of points 215, shown generically in FIG. 2A. The invention admits wide variation in how this attachment may be accomplished, and may employ virtually any suitable attachment mechanism. FIG. 3-FIG. 6 each illustrate various alternative embodiment employing and implementing different attachment mechanisms. More particularly:
FIG. 3 illustrates an embodiment in which the attachment is made through electronics modules 305 being connected to both a signal cable 210 and a support cable 205-A;
FIG. 4 illustrates the deployment of an embodiment in which the attachment is made through a zipper mechanism;
FIG. 5 illustrates an embodiment in which the support cable 205 and the signal cable 210 are separated after fabrication by a rip-cord 505; and
FIG. 6 illustrates an embodiment in which the attachment is made by a rigid arm 610.
   Each of these alternative embodiments shall now be discussed more fully in turn.

FIG. 3 illustrates one embodiment of the seismic cable 110, in which an electronics module 305 separating two support cable sections referred in FIG. 3 as a left support cable section 205-A and a right support cable section 205-B section. As mentioned, the electronics module 305 is placed at intervals along the seismic cable 110 of FIG. 1 and FIG. 2A and is generally placed between the support cable sections 205-A, 205-B.

As illustrated in FIG. 3, the signal cable 210 is directly connected to the electronics module 305. In one embodiment, the left support cable section 205-A terminates on one side of the electronics module 305 and begins anew at the right support cable 205-B at another side of the electronics module 305. In an alternative embodiment, the support cable sections 205-A, 205-B pass through the electronic module 305.

Although not illustrated in FIG. 3, it should be appreciated that at least of a portion the support cable sections 205-A, 205-B and signal cable 210 may be connected by some other attachment mechanism in addition to the attachment provided at the sensor module 305. For instance, the embodiment of FIG. 3 might also employ the rigid or semi-rigid arm 610 in FIG. 6, discussed more fully below. Thus, some embodiments might use several different types of attachment mechanisms.

FIG. 4 illustrates an embodiment of the seismic cable 110 in FIG. 1 alternative to that of FIG. 3. A storage and deployment mechanism 405 is shown, which stores a continuous length of support cable 205 in a support cable storage 410 and a continuous length of signal cable 210 in a signal cable storage 415. As mentioned, the sensor module 220 and the electronics module 305 are directly connected to the signal cable 210 and are stored along with the signal cable 210 in the signal cable storage 415. It should be appreciated that although the support cable storage 410 and the signal cable storage 415 are illustrated in a common “spool” configuration, any method of storing a continuous length of cable known in conventional practice may be used.

The support cable 205 and the signal cable 210 are attached at one end by a zipper mechanism 420. As the support cable 205 is deployed from the support cable storage 410 and signal cable 210 is removed from signal cable storage 415, the zipper mechanism 420 is guided in the direction of the spools 410, 415, thereby automatically attaching the support cable 205 with the signal cable 210. The zipper mechanism 420 can be any mechanism known in the art for automatically clamping two members in a zipping fashion. For example, the zipper mechanism 420 may comprise a plurality of clamps that are individually operated to attach the support cable 205 with the signal cable 210. The plurality of clamps may be located on the support cable 205, the signal cable 210, or both. Another example of the zipper mechanism is a Velcro-based solution. Yet another example of a zipper mechanism is strong thread that attaches the signal cable to the support cable by sowing, wrapping or knitting.

Because the sensor module 220 and the electronics module 305 are attached to the signal cable 210 without tension, the signal cable 210 will be subjected to relatively gentler handling. Furthermore, this embodiment of the seismic cable 110 allows for greater operation depth and easier handling in adverse weather. The design also allows easier and faster replacement of component parts in the seismic cable 110. Still further, because the signal cable 210 and support cable 205 can be stored without tension, less space is needed in the signal cable storage 415 and the support cable storage 410, respectively. One important feature of this arrangement is that the signal cable 210 is handled and stored with virtually no tension. This creates an opportunity for the cable designer to avoid certain conflicting requirements like cable strength vs. unwanted inter-cable acoustic coupling.

Note that, in some embodiments, the electronics module can be carried as part of the support cable 205, as opposed to the signal cable 210. In such an embodiment, the support cable 205 comprises one or more electronics modules 305 (first shown in FIG. 3) connected to one or more leads in the support cable 205. The leads may be electrical or optical, depending on their purpose and the particular embodiment. The leads may be for transmitting data and power for the operation of the electronics modules 305. For instance, signal leads (e.g. the signal leads 240 shown in FIG. 2C) may be used to transmit data from the electronics modules 305 to, e.g., a computing device (not shown) located on the seismic survey vessel 105 (first shown in FIG. 1) or at the remote location. Similarly, leads may be employed for transmitting power from the survey vessel 105 to the electronics modules 305.

One example of such a seismic cable 110 is illustrated in FIG. 5. The support cable 205 and the signal cable 210 are manufactured together in one continuous unit and substantially enclosed by the protective outer covering 230. The signal cable 210 can be detached over short sections where the sensor modules (not shown in FIG. 5) are desired by pulling a rip-cord 505. Detaching the signal cable 210 from the seismic cable 110 leaves an empty groove 510. If the outer covering 230 is comprised of a thermoplastic, the rip-cord 505 can be heated by electrical current, for example, to ease pulling the rip-cord 510. Once the signal cable 210 is detached, it can be terminated and connected to the sensor module 220. The support cable 205, in the embodiment of FIG. 6, includes several signal leads 515 (only one indicated) over which control and data signals may be transmitted and a power lead 520 over which the electronic modules 320 may be powered.

FIG. 6 illustrates an alternative embodiment of the attachment mechanism 215 of FIG. 2A. Arm 610 separates the support cable 205 from the signal cable 210 at a sufficient distance such that the support cable 205 and the signal cable 210 do not contact during deployment. In alternative embodiments, the arm 610 may be rigid or semi-rigid. A semi-rigid arm 610 will flex along the direction of the signal cable 210 but be rigid in the direction of rotation about the signal cable 210. The arm 610 is attached to the support cable 205 by a clamp 615. The arm 610 should generally be attached loosely to the signal cable 210 such that excess torsion is not introduced into the signal cable 210. For example, as illustrated in FIG. 6, the arm 610 is attached to the signal cable 210 by a bearing 620 that allows the signal cable 210 to rotate freely around the signal cable 210 and move axially between two stop clamps 625.

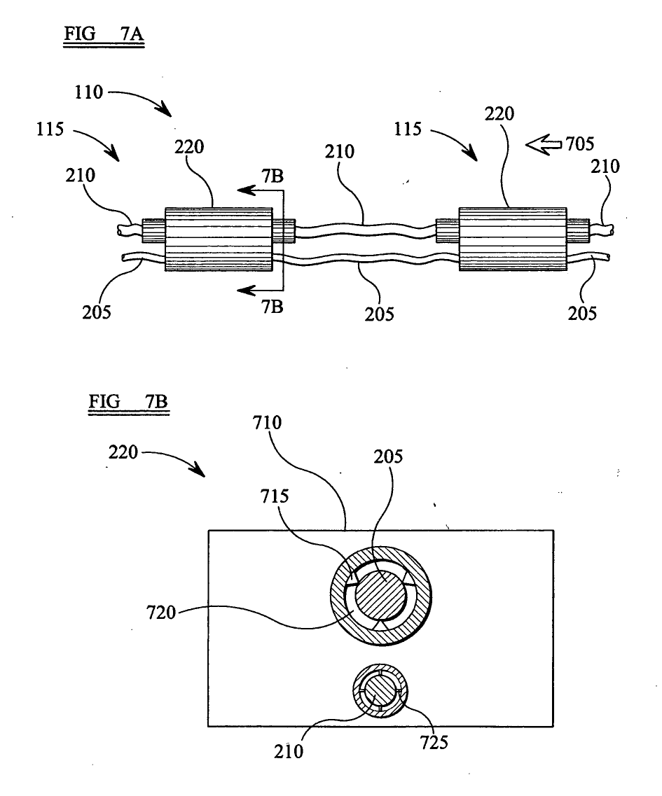

FIG. 7A and FIG. 7B illustrate another alternative embodiment in which the support cable 205 and the signal cable 210 are attached by the housings of the sensor modules 220 themselves. The view in FIG. 7B is from the direction of the arrow 705 in FIG. 7A and sectioned along the line 7B-7B in FIG. 7A. As was alluded to earlier, the support cable 205 is acoustically decoupled from the housing 710 of the sensor module 220 by a plurality of elastic devices 715 (only one indicated), such as springs, as is shown in FIG. 7B. In some alternative embodiments, the elastic devices 715 may be omitted. Note that a plurality of electrical connections 725 (only one indicated) are conceptually illustrated between the signal cable 210 and the sensor module 220.

The elastic devices 715 are positioned between the support cable 705 and the sensor housing 710 in the groove 720 defined by the sensor housing 710 and through which the support cable 205 runs. Such decoupling techniques are known to the art and one is more fully disclosed in International Patent WO0214905, published Feb. 21, 2002, in the name of James Martin, Nicolas Goujon, Frederik Naes, and Rune Voldsbekk, and entitled “A HOUSING FOR A SEISMIC SENSING ELEMENT AND A SEISMIC SENSOR” However, other techniques may also be employed in alternative embodiments. For instance, some embodiments, the support cable is decoupled from the sensor housing 710 by being permitted to slide freely through the groove 720 relative to the sensor module 220.

The present invention facilitates acoustic decoupling of the sensor modules 220—and, hence, the sensors—from the stress member 205, which is rigid and under tension, and therefore improves the data quality recorded by the system 100. The various embodiments described herein provide a robust cable 110 capable of being subjected to rough handling when the cable 110 is deployed and/or retrieved. The robust cable 110 is further capable of being subjected to great water depth and pressure. Although the cable 110 is substantially robust, the cable 110 delivers higher data quality than previous cables. More particularly, in its various aspects and embodiments, the invention provides the following advantages over the state of the art:
higher reliability of the connections to the sensor modules 220, as takeouts are eliminated;
reduced number of connections;
increased cable strength as terminations of the stress member 205 are eliminated;
improved sensor-to-ground coupling due to the smaller and lighter sensor module 220;
more precise data recording independent of how the sensor module 220 rests on the seafloor due to axial symmetry of the cable 110 and sensor module 220;
mechanical decoupling between the sensor module 220 and the support cable, thus freeing the sensor module 220 from the stresses on the stress member 205 and improving data quality;
high data quality independent of water depth;
higher possibility for the same axial symmetry for the cable 110 as for the sensor module 220 and for positioning the sensor module 220 closer to the center of gravity of the sensor module 220—thereby providing consistent and repeatable independent of bow the sensor module 220 lies on the seafloor;
higher modularity of cable construction providing increased reparability, reconfiguration possibilities, improved depth-appropriate assembly, and even the possibility of omitting stress carrying support for shallow water operations;
easier handling procedures, as the stress member 205 and the signal cable 210 can be separated for storage and shipping; and
safer handling for components since the sensor module 220 can be stored separately from the stress member 205, thereby reducing danger to the sensor module 220 from tension on the stress member 205.
   Note that not all of these advantages will be realized in every embodiment of the invention. Still other advantages may become apparent to those skilled in the art having the benefit of this disclosure.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spit of the invention. Accordingly, the protection sought herein is as set forth in the claims below.

1. A seismic cable, comprising:
a support cable;
a signal cable attached to the support cable at a plurality of points spaced along the length of the signal cable; and
at least one sensor module disposed on the signal cable.

2. The seismic cable of claim 1, further comprising a first sheath enclosing the support cable and the signal cable.

3. The seismic cable of claim 2, wherein the first sheath comprises at least one of is a skin, a jacket or an extrusion matrix.

4. The seismic cable of claim 1, wherein the support cable includes a plurality of strengthening members.

5. The seismic cable of claim 4, wherein the strengthening members are cabled by a second sheath.

6. The seismic cable of claim 1, wherein the support cable includes at least one of a signal lead and a power lead.

7. The seismic cable of claim 6, further comprising an electronics module powered over the power lead and capable of transmitting data over the signal lead.

8. The seismic cable of claim 7, wherein the support cable is sectioned.

9. The seismic cable of claim 1, wherein the signal cable includes a plurality of leads cabled by a third sheath.

10. The seismic cable of claim 1, wherein the signal cable includes at least one strengthening member.

11. The seismic cable of claim 1, further comprising a plurality of sensor modules electrically connected to the signal cable.

12. The seismic cable of claim 1, wherein the sensor modules transmit data and receive power over the signal cable.

13. The seismic cable of claim 1, further comprising:
a plurality of sensor modules electrically connected to and distributed along the signal cable; and
a plurality of electronics modules by which the signal cable is attached to the support cable at the points.

14. The seismic cable of claim 1, wherein the electronics modules are electrically connected to the signal cable at the points and mechanically connected to the support cable.

15. The seismic cable of claim 1, wherein the signal cable is attached to the support cable by a zipper mechanism.

16. The seismic cable of claim 1, wherein the plurality of points are spaced along the length of the signal cable in proportion to a length of the sensor module.

17. The seismic cable of claim 16, wherein the plurality of points are positioned between adjacent sensor modules

18. The seismic cable of claim 16, wherein the separations are created by pulling a rip cord fabricated in the seismic cable to detach the signal cable from the support cable.

19. The seismic cable of claim 1, further comprising a plurality of arms mechanically affixed to the support cable and rotationally connected to the signal cable to attach the signal cable to the support cable at the points.

20. The seismic cable of claim 19, wherein the arms are at least one of rigid and semi-rigid arms.

21. The seismic cable of claim 19, wherein the arms are mechanically fixed by a plurality of clamps.

22. The seismic cable of claim 19, wherein the arms are rotationally connected by a bearing.

23. The seismic cable of claim 19, further comprising a plurality of stops restraining movement of the rotational connection along the length of the signal cable.

24. The seismic cable of claim 1, further comprising a plurality of sensor modules electrically connected to and distributed along the signal cable and by which the support cable and the signal cable are joined.

25. The seismic cable of 24, wherein the support cable passes through a groove in the sensor modules.

26. The seismic cable of claim 1, wherein each of the sensor modules comprises a housing defining a groove therethrough through which the support cable runs.

27. The seismic cable of claim 26, wherein the support cable is acoustically decoupled from the housing by a plurality of elastic devices.

28. The seismic cable of claim 26, wherein the support cable is acoustically decoupled from the housing by freely moving through the groove relative to the sensor module.

29. A method for assembling a seismic cable, comprising attaching a support cable to a signal cable at a plurality of points spaced along the length thereof.

30. The method of claim 29, wherein attaching the support cable to the signal cable includes mechanically connecting an electronics module to the support cable and electrically connecting the electronics module to the signal cable.

31. The method of claim 29, wherein attaching the support cable to the signal cable includes zipping the signal cable to the support cable at the points.

32. The method of claim 29, wherein attaching the support cable to the signal cable includes separating the support cable and the signal cable between the points.

33. The method of claim 32, wherein separating the support cable and the signal cable includes pulling a rip-cord.

34. The method of claim 29, wherein attaching the support cable to the sensor includes mechanically affixing at least one of a rigid and a semi-rigid arm to the support cable and rotationally connecting the respective rigid or semi-rigid arm to the signal cable at each of the points.

35. The method of claim 29, wherein attaching the support cable to the signal cable includes connecting the support cable to the signal cable by a plurality of sensor modules.
